(19) United States
(12) Patent Application Publication
(10) Pub. No.: US 2008/0152301 A1
(43) Pub. Date: Jun. 26, 2008

(54) PLAYBACK CONTROL APPARATUS AND METHOD

(76) Inventor: Min Haeng CHO, Gyeonggi-do (KR)

Correspondence Address: KED & ASSOCIATES, LLP, P.O. Box 221200, Chantilly, VA, 20153-1200, US

(21) Appl. No.: 11/962,402

(22) Filed: Dec. 21, 2007

(30) Foreign Application Priority Data
Dec. 21, 2006 (KR) 10-2006-0131589

(51) Int. Cl. H04N 5/91

(52) U.S. Cl. 386/68

(57) ABSTRACT

This document relates to a playback control method and apparatus. The apparatus according to an embodiment of this document may comprise a playback unit for reading and playing back a data stream stored in a recording medium, an input unit for receiving a status change request from a user, and a control unit for, if a status change request to change a current playback status is input, offsetting a time point at which the requested new playback status is to be applied, and controlling the playback unit to apply the new playback status from the offset time point. A status change may indicate a playback speed change or screen stop. An offset value for the time point at which the new playback status is to be applied may be calculated based on a current playback speed, a playback direction, a user reaction time, and a system reaction time.

This nonprovisional application claims priority under 35 U.S.C. §119(a) on Patent Application No. 10-2006-0131589 filed in Republic of Korea on Dec. 21, 2006 the entire contents of which are hereby incorporated by reference.

### BACKGROUND

1. Field

This document relates to a playback control apparatus and method.

2. Related Art

In recent years, various kinds of digital video recorders, such as a Set Top Box (STB) or Digital Television (D-TV) equipped with a Personal Video Recording (PVR) function of receiving digital broadcasting and recording it into a recording medium such as a hard disk drive (HDD), have been commercialized and popularized.

A modern user reserves a desired broadcasting program and records it into a recording medium using the digital video recorder, and watches the recorded broadcasting program later on. The user plays back an interested scene at an original speed or pauses the scene while playing the recorded broadcasting program at high speed. If a desired scene appears while playing the program recorded into the recording medium at high speed, a user tries to change the playback speed to an original speed or pause the program at the desired scene using a remote control unit, etc. At this time, there exists a time lag between a location where the program is played back at an original speed or paused and a location of the scene desired by a user.

In other words, the program is played back beginning a scene posterior to the scene desired by the user. It makes a user manually perform a search operation again in an opposite direction using a remote control unit or the like. In a similar way as the high-speed playback operation is performed in a reverse direction, the user has to perform the search operation again in an opposite direction since the program is played back beginning a scene anterior to a scene desired by the user.

### SUMMARY

Accordingly, this document has been made keeping in mind the above problems occurring in the prior art, and an aspect of this document is to provide a method of playing back a program at an exact location selected by a user during the high-speed playback.

In an aspect, a playback control method comprises confirming a request to change a current playback status, and offsetting a time point at which the requested new playback status is to be applied.

In another aspect, a playback control apparatus comprises a playback unit for reading and playing back a data stream stored in a recording medium, an input unit for receiving a status change request from a user, and a control unit for, if a status change request to change a current playback status is input, offsetting a time point at which the requested new playback status is to be applied, and controlling the playback unit to apply the new playback status from the offseted time point.

In the above embodiments, the status change may comprise a playback speed change or screen stop. An offset value for the time point at which the new playback status is to be applied may be calculated based on a current playback speed, a playback direction, a user reaction time, and a system reaction time.

Further, the offset value may be calculated by multiplying a sum of the user reaction time and the system reaction time by a value corresponding to the current playback speed. The new playback status may be applied by moving a location in an opposite direction to a current playback direction from a time point at which the current playback status is stopped (that is, in a backward direction when the current playback status is forward playback, and in a forward direction when the current playback status is backward playback). A location to be moved may be decided based on information in which a playback time and a recorded location of the data stream are associated, and a bit rate of data that is being played back.

Moreover, the user reaction time may comprise an experimental value from when a user selects a desired scene to when the request is input. The system reaction time may comprise an experimental value from when the request is input to when the new playback status is applied. The user reaction time and the system reaction time may be stored in non-volatile memory.

### BRIEF DESCRIPTION OF THE DRAWINGS

The implementation of this document will be described in detail with reference to the following drawings in which like numerals refer to like elements.

FIGS. 1 and 2 illustrate general playback control processes;

FIG. 3 shows a construction of a digital video recorder to which this document is applied;

FIG. 4 is a flowchart illustrating an operation of a playback control method according to this document; and

FIGS. 5 and 6 illustrate embodiments of a playback control process according to this document.

### DETAILED DESCRIPTION

Hereinafter, implementations of this document will be described in detail with reference to the attached drawings.

There is some time lag between a time point at which a user recognizes a desired scene from moving-picture content that is played back and a time point at which a command is input to a system (that is, a time point at which a button corresponding to a desired function such as a pause button in a remote control unit or the like is manipulated). This time lag is called a user reaction time A. Further, time taken for a system to receive a user input and perform a corresponding operation in reaction to the user input is called a system reaction time B.

In general, the user reaction time may be 200 ms, which is a simple reaction time responding to a simple visual stimulus that was experimentally known. The system reaction time is very shorter than the user reaction time and may be 100 ms or less, which is a concept for correction of the user reaction time.

The system reaction time may vary a little depending on the status of a system (that is, playback conditions, and so on). It can be said that an absolute time, which is taken from when a user recognizes a desired scene and inputs an instruction to a system to when the system responds to the instruction, is constant.

For example, there is a time lag (A+B) in which the user reaction time A and the system reaction time B are added between a time point at which a user selects a desired scene during 2×-speed playback and a time point at which 1×-speed playback actually begins. In a similar way, there is a time lag (A+B) between a time point at which a user selects a desired scene during 4×-speed playback and a time point at which 1×-speed playback actually begins.

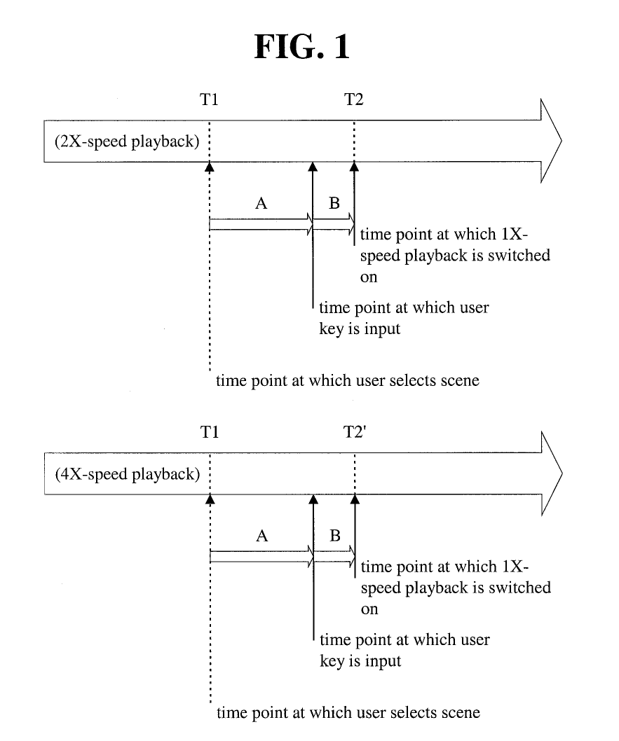

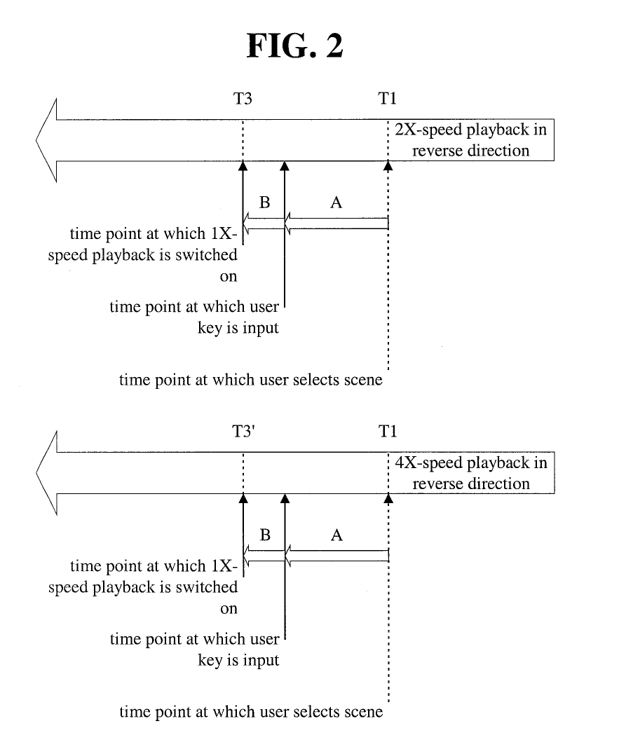

However, there inevitably occurs a relative elapse time lag in moving-picture content that is played back depending on a current playback status (that is, a playback speed). As shown in FIG. 1, an elapse time within content from a scene desired by a user to a scene played back after the playback speed changes to the 1×-speed when the playback speed is 4×-speed is twice those when the playback speed is 2×-speed. This is true of a case where moving-picture content that is played back at high speed in a reverse direction is to be paused at a desired scene, as shown in FIG. 2.

Thus, in this document, in order for moving-picture content to be played back at an accurate location selected by a user during high-speed playback, an time offset between a location selected by a user and a current location to which playback mode requested by the user will be applied is calculated based on a current playback speed and direction and the user and system reaction times, and the requested playback mode is then applied from a location apart from the current location by the calculated offset in an opposite direction to a playback direction where the moving-picture content is being played back.

A playback control apparatus and method according to this document may be applied to various kinds of digital video recorders, such as a STB and D-TV equipped with the PVR function, and may also be applied to various types of digital video players such as DVD player and Dvix player.

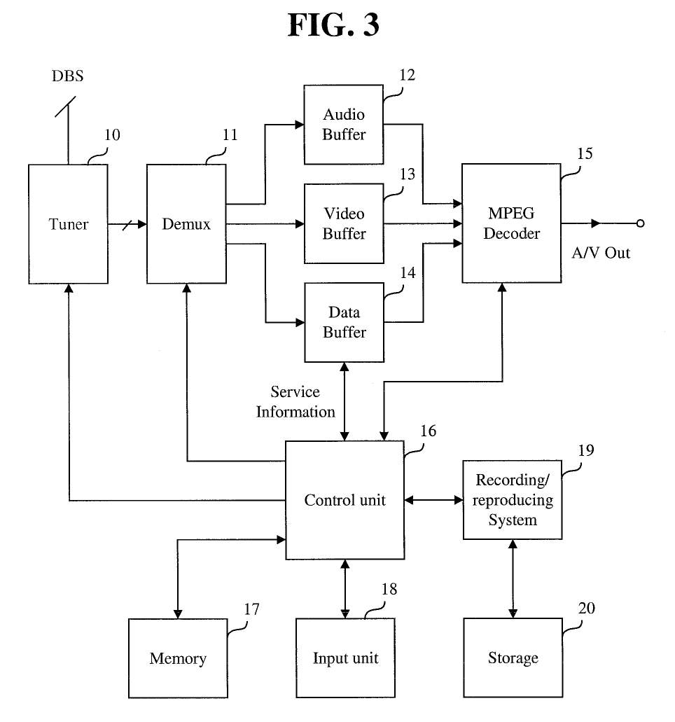

For example, a digital video recorder to which this document is applied may comprise, as shown in FIG. 3, a tuner 10, a demux 11, an audio buffer 12, a video buffer 13, a data buffer 14, a MPEG decoder 15, a control unit 16, memory 17, an input unit 18, a recording/reproducing system 19, a hard disk storage 20, and so on.

If broadcasting recording is requested through the input unit 18, the control unit 16 controls the recording/reproducing system 19 to record broadcasting program data of a MPEG-2 transport stream, which is received through the tuner 10 and the demux 11, into the storage 20 such as a large capacity of a hard disk, an optical disk or flash memory.

The control unit 16 extracts time information, such as a Presentation Time Stamp (PTS), from the data stream of the broadcasting program recorded into the storage 20, generates a log file in association with a recording location of the data stream corresponding to each time, and stores the generated log file in the memory 17, or searches for bit rate information about the data stream of the recorded broadcasting program and stores the searched bit rate information in the memory 17. For example, the memory 17 may comprise non-volatile flash memory or the like.

Further, in the memory 17, the user reaction time A and the system reaction time B are stored as resultant values of previously performed experiments. For example, the user reaction time may be stored as A=200 ms and the system reaction time may be stored as B=100 ms.

If a playback operation of a recorded broadcasting program is requested through the input unit 18, the control unit 16 controls the recording/reproducing system 19 to read data streams of a corresponding broadcasting program and play back the data streams.

Meanwhile, if 1×-speed playback or screen pause is requested through the input unit 18 according to a user's request while a recorded broadcasting program is played back at high-speed playback, the control unit 16 determines a current playback direction and at the same time switches the playback mode to the 1×-speed playback mode or the screen pause mode.

At this time, the control unit 16 calculates an offset value based on the current playback direction and speed, and the user reaction time and the system reaction time stored in the memory 17, and controls the recording/reproducing system 19 to move a current location to a location by the calculated offset value in an opposite direction to the current playback direction so that the 1×-speed playback operation begins or the screen is paused at the moved location. Thus, a user can begin the 1×-speed playback operation or stop the screen at a desired scene. This is described in detail below.

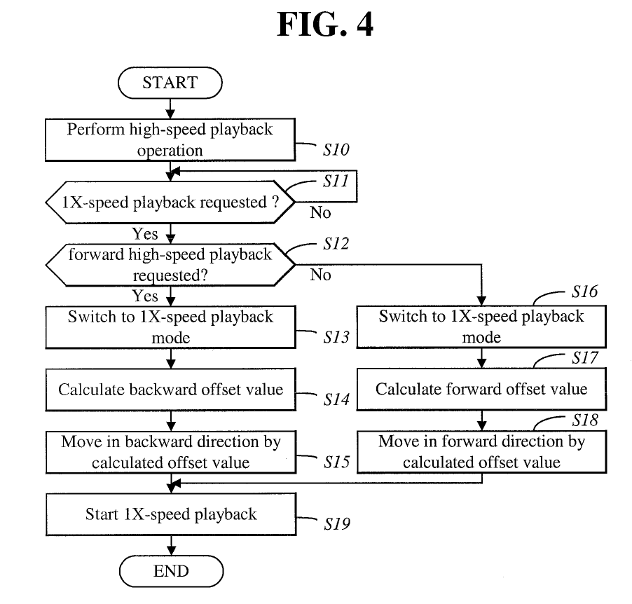

FIG. 4 is a flowchart illustrating an operation of a playback control method according to this document.

The control unit 16 controls the recording/reproducing system 19 to perform a high-speed playback operation of reading and playing back data streams of a broadcasting program recorded on the storage 20 at 2×-speed or higher according to a user's request in S10.

If a 1×-speed playback operation or screen pause is requested through the input unit 18, etc. during the high-speed playback operation in S11, the control unit 16 determines a current playback direction in S12. For example, if, as a result of the determination in step S12, it is determined that the current playback direction is forward high-speed playback, the control unit 16 controls the recording/reproducing system 19 to switch the current mode to an operating mode requested by the user (for example, the 1×-speed playback mode or the screen pause mode) in S13.

The control unit 16 then calculates an offset value for backward movement in a reverse direction on the basis of the high-speed playback direction and speed, and the user reaction time A and the system reaction time B stored in the memory 17 in S14.

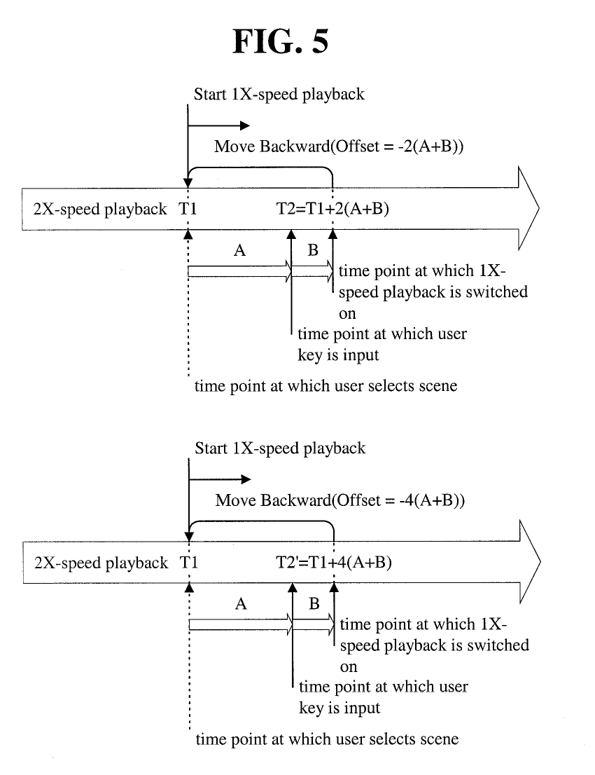

For example, if a 1×-speed playback operation is requested during a 2×-speed playback operation of a forward direction as shown in FIG. 5, the control unit 16 sums the user reaction time A and the system reaction time B stored in the memory 17 and then multiplies the sum (A+B) by a coefficient K corresponding to the previous high-speed playback speed, thus calculating an offset value −K*(A+B). The coefficient K is a value proportional to the playback speed, and may be, for example, K=2 in the case of 2×-speed playback, K=4 in the case of 4×-speed playback, or K=8 in the case of 8×-speed playback.

The offset value has a negative value when a current playback direction is forward and a positive value when a current playback direction is backward. For example, as shown in FIG. 5, when an offset value in the case of 2×-speed playback of a forward direction is −2*(A+B), an offset value in the case of 4×-speed playback of a forward direction may be −4*(A+B).

After the offset value in the reverse direction is calculated, the control unit 16 controls the recording/reproducing system 19 to move a current location to a location corresponding to the calculated offset value in the backward direction in S15.

In other words, the control unit 16 controls the recording/reproducing system 19 to perform the backward movement operation to a recording location corresponding to the offset value by reference to a log file stored in the memory 17 or bit rate information of a data stream of the broadcasting program.

Thereafter, the control unit 16 controls the recording/reproducing system 19 to start the 1×-speed playback operation or pause the screen at the moved recording location. Accordingly, a user can start the 1×-speed playback or pause the screen at a desired scene.

Meanwhile, if, as a result of the determination in step S12, it is determined that the current playback direction is backward high-speed playback, the control unit 16 controls the recording/reproducing system 19 to switch a current mode to the 1×-speed playback mode or the screen pause mode in S16 and at the same time calculates an offset value for forward movement on the basis of the high-speed playback direction and speed, and the user reaction time A and the system reaction time B stored in the memory 17 in S17.

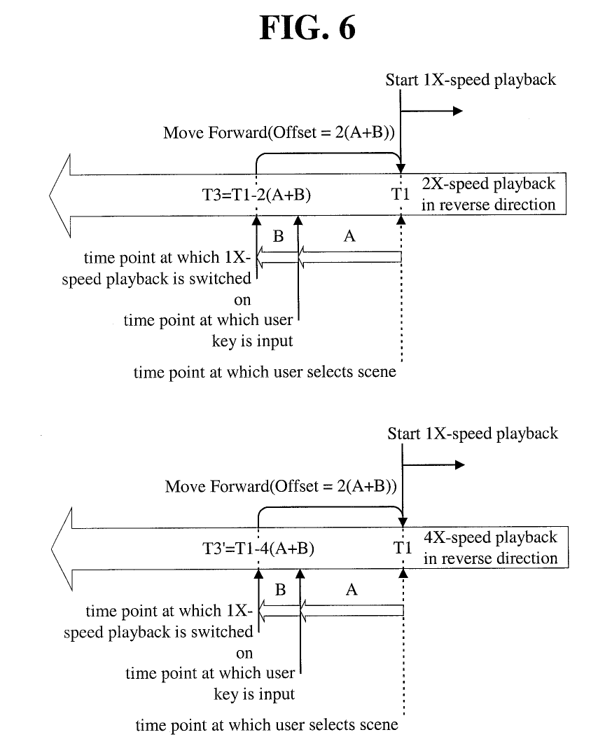

For example, if a 1×-speed playback operation is required during a 2×-speed playback operation of a reverse direction as shown in FIG. 6, the control unit 16 sums the user reaction time A and the system reaction time B stored in the memory 17 and then multiplies the sum (A+B) by a coefficient K corresponding to the high-speed playback speed, thus calculating an offset value K*(A+B). For example, when an offset value in the case of 2×-speed playback of a reverse direction is 2*(A+B), an offset value in the case of 4×-speed playback of a reverse direction may be 4*(A+B).

After the offset value in the forward direction is calculated, the control unit 16 controls the recording/reproducing system 19 to move a current location to a location corresponding to the calculated offset value in the forward direction in S18.

The control unit 16 controls the recording/reproducing system 19 to start the 1×-speed playback operation or pause the screen at the moved recording location. Accordingly, a user can start the 1×-speed playback or pause the screen at a desired scene in S19.

In the above embodiments, an example in which 1×-speed playback or screen pause is requested while high-speed playback of 2×-speed or more is performed has been described. However, the present embodiments may also be applied to an example in which screen pause or lower speed playback is requested while 1×-speed playback or playback lower than 1×-speed is performed.

In this case, a requested operation may be performed by moving to a location in an opposite direction to a current playback direction by an amount corresponding to the multiplication of (A+B) and a current speed. For example, in the event that screen pause is requested in 1×-speed playback of a forward direction, a scene as earlier as the time (A+B) may be treated as a still screen. In the event that screen pause is requested in 1×-speed playback of a backward direction, a scene as later as the time (A+B) may be treated as a still screen. In the event that screen pause is requested in ½×-speed playback of a forward direction, a scene as earlier as the time 0.5(A+B) may be treated as a still screen.

While this document has been described in connection with what is presently considered to be practical exemplary embodiments, it is to be understood that this document is not limited to the disclosed embodiments, but, on the contrary, is intended to cover various modifications and equivalent arrangements included within the spirit and scope of the appended claims.

Accordingly, a time lag between a scene desired by a user and a scene at which playback is started or paused can be offset. Consequently, a user's convenience can be increased.

What is claimed is:

1. A playback control method, comprising:
confirming a request to change a current playback status; and
offsetting a time point at which the requested new playback status is to be applied.

2. The playback control method of claim 1, wherein the status change comprises a playback speed change or screen pause.

3. The playback control method of claim 2, wherein an offset value for the time point at which the new playback status is to be applied is calculated based on a current playback speed, a playback direction, a user reaction time, and a system reaction time.

4. The playback control method of claim 3, wherein the offset value is calculated by multiplying a sum of the user reaction time and the system reaction time by a value corresponding to the current playback speed.

5. The playback control method of claim 3, further comprising applying the new playback status to a time point apart from a time point at which the current playback status is stopped by the calculated offset value.

6. The playback control method of claim 5, wherein the offset value has a negative value when the current playback status is forward playback, and the offset value has a positive value when the current playback status is backward playback.

7. The playback control method of claim 5, wherein a location corresponding to the time point is decided based on information in which a playback time and a recorded location of the data stream are associated or a bit rate of data that is being played back.

8. The playback control method of claim 3, wherein:
the user reaction time comprises an experimental value from when a user selects a desired scene to when the request is input,
the system reaction time comprises an experimental value from when the request is input to when the new playback status is applied, and
the user reaction time and the system reaction time are stored in non-volatile memory.

9. A playback control apparatus, comprising:
a playback unit for reading and playing back a data stream stored in a recording medium;
an input unit for receiving a status change request from a user; and
a control unit for, if a status change request to change a current playback status is input, offsetting a time point at which the requested new playback status is to be applied, and controlling the playback unit to apply the new playback status from the offseted time point.

10. The playback control apparatus of claim 9, wherein the status change comprises a playback speed change or screen stop.

11. The playback control apparatus of claim 10, wherein the control unit calculates an offset value for the time point at which the new playback status is to be applied based on a current playback speed, a playback direction, a user reaction time, and a system reaction time.

12. The playback control apparatus of claim 11, wherein the control unit calculates the offset value by multiplying a sum of the user reaction time and the system reaction time by a value corresponding to the current playback speed.

13. The playback control apparatus of claim 11, wherein the control unit controls the playback unit to apply the new playback status after moving a time point at which the current playback status is stopped as much as the calculated offset value.

14. The playback control apparatus of claim 13, wherein the offset value has a negative value when the current playback status is forward playback, and the offset value has a positive value when the current playback status is backward playback.

15. The playback control apparatus of claim 13, wherein the control unit decides a location to be moved based on information in which a playback time and a recorded location of the data stream are associated, and a bit rate of data that is being played back.

16. The playback control apparatus of claim 11, further comprising:
non-volatile memory for storing the user reaction time and the system reaction time,
wherein the user reaction time comprises an experimental value from when a user selects a desired scene to when the request is input, and the system reaction time comprises an experimental value from when the request is input to when the new playback status is applied.
